(19) United States
(12) Patent Application Publication
(10) Pub. No.: US 2004/0184697 A1
(43) Pub. Date: Sep. 23, 2004

(54) Polarization control apparatus

(76) Inventors: Cheng-Hsi Miao, San Jose, CA (US); Ying-Moh Liu, Saratoga, CA (US)

Correspondence Address: Billy Lau, 486 Vista Del Norte, Walnut, CA, 91789-1605, US

(21) Appl. No.: 10/391,715

(22) Filed: Mar. 18, 2003

(51) Int. Cl. G02B 6/26

(52) U.S. Cl. 385/11

(57) ABSTRACT

The present invention relates to a polarization control apparatus. An embodiment of the present invention comprises a first and a second polarizing beam displacers, and a first and a second liquid crystal cells with both cells being responsive to external signals. The first polarizing beam displacer separates an input light beam into two substantially mutually orthogonal polarized light beams. Each of the two polarized light beams is rotated in polarization by at least one of the liquid crystal cells into a rotated polarized light beam. The second polarizing beam splitter combines substantially predetermined polarization components of the two rotated polarized light beams into an output light beam. Optionally, optically fiber collimators are disposed to provide the input light beam and receive the output light beam. The present invention may be adapted to multiple optical channel applications.

### FIELD OF THE INVENTION

This invention generally relates to an optical polarization control apparatus. Particularly, this invention relates to a polarization control apparatus that is controllable through external signals.

### BACKGROUND OF THE INVENTION

Polarization control apparatuses are widely used in optical systems. These polarization control apparatuses have one or more channels. Each channel is dependently controllable. In the past, most of the polarization control apparatuses are either fixed or manually adjustable. A polarization control apparatus that is controllable through external signals is highly desirable for numerous applications, including dynamic control of polarization. One skilled in the art understands that a polarization control apparatus can perform functions other than polarization control. With the advent of dynamically reconfigurable optical fiber communication systems, dynamic control of polarization becomes a necessity. It is an object of this invention to provide a polarization control apparatus that is controllable through external signals.

### SUMMARY OF THE INVENTION

According to this invention, an embodiment of an polarization control apparatus that is responsive to external control signals and has an optical input port and an optical output port comprises a first polarizing beam displacer and a second polarizing beam displacer, and a first liquid crystal cell and a second liquid crystal cell. The liquid crystal cells are responsive to external signals. The first polarizing beam displacer separates a light beam from the optical input port into two substantially mutually orthogonal polarized light beams. Each of the two polarized light beams is rotated in polarization by at least one of the liquid crystal cells into a rotated polarized light beam. The second polarizing beam splitter combines substantially predetermined polarization components of the rotated polarized light beams into a light beam at the optical output port. Optionally, optically fiber collimators are disposed to provide the input light beam and receive the output light beam. The present invention may be adapted to multiple optical channel applications.

### DESCRIPTION OF THE DRAWINGS

A better understanding of the invention may be gained from the consideration of the following detailed descriptions taken in conjunction with the accompanying drawings in which:

FIG. 1 shows the configuration of an embodiment of the present invention that has a single channel.

FIG. 2 shows the configuration of an alternative embodiment of the present invention that has two channels.

### DETAILED DESCRIPTION OF THE INVENTION

In the description that follows, like parts are indicated throughout the specification and drawings with the same reference numerals. The present invention is not limited to the specific embodiments illustrated herein.

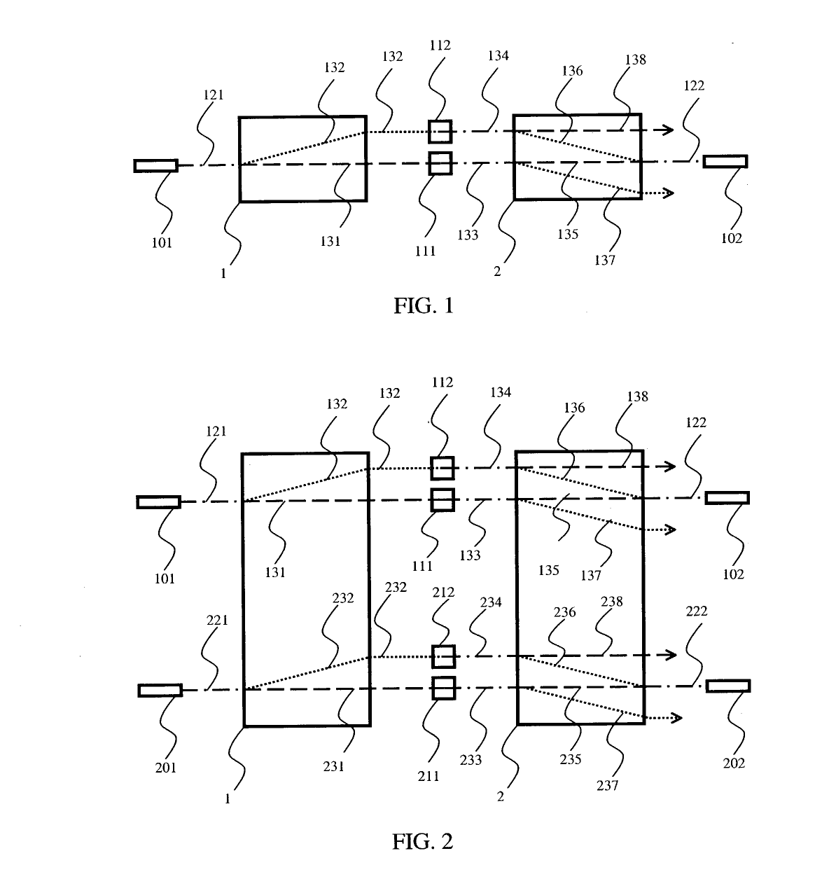

FIG. 1 shows the configuration of an embodiment that has one optical channel according to this invention. There is an input port and an output port associated with the optical channel. Referring to FIG. 1, a light beam from input optical fiber collimator 101, which is located at the input port, propagates along light path 121 and enters polarizing beam displacer 1. A polarizing beam displacer is a special polarizing beam splitter that outputs two parallel and polarized light beams. In contrast, a generic polarizing beam splitter outputs two polarized light beams that are at an angle with respect to each other and therefore not parallel. According to this invention, a generic polarizing beam splitter can be used instead of a polarizing beam displacer. Nevertheless, the optical arrangement for using a generic polarizing beam splitter instead of a polarizing beam displacer may be more complex.

Polarizing beam displacer 1 separates the light beam from input optical fiber collimator 101 into two polarized light beams. One skilled in the art readily understands the operation of a polarizing beam displacer and that these polarized light beams are commonly referred as P-polarized light beam and S-polarized light beam. Further, the P-polarized light beam and the S-polarized light beam from a physical beam displacer have substantially mutually orthogonal polarizations and are substantially parallel. The P-polarized light beam propagates through polarizing beam displacer I to first liquid crystal cell 111 along light path 131, which is one of the dash line segments in FIG. 1. The S-polarized light beam propagates through polarizing beam displacer 1 to second liquid crystal cell 112 along light path 132, which is shown as two dotted line segments in FIG. 1.

First liquid crystal cell 111 rotates the polarization of the P-polarized light beam from polarizing beam displacer 1 into a first rotated light beam in response to a first external applied signal voltage. Typically a liquid crystal cell such as first liquid crystal cell 111 and second liquid crystal cell 112 can rotate the polarization of the light beam from zero degree to ninety degrees depending on the design of the liquid crystal cell and the range of external signal voltage applied to the liquid crystal cell. The first rotated light beam may contain both P-polarized and S-polarized components. The first rotated light beam propagates along light path 133. Similarly, second liquid crystal cell 112 rotates the polarization of the S-polarized light beam from polarizing beam displacer 1 into a second rotated light beam in response to a second external applied signal voltage. The second rotated light beam may contain both P-polarized and S-polarized components. The second rotated light beam propagates along light path 134 to second polarizing beam displacer 2.

Polarizing beam displacer 2 separates the P-polarized component and the S-polarized component of the first and second rotated light beam. The S-polarized component of the first rotated light beam from first liquid crystal cell 111 propagates along light path 137. The P-polarized component of the second rotated light beam from second liquid crystal cell 112 propagates along light path 138. The P-polarized component of the first rotated light beam from first liquid crystal cell 111 propagates along light path 135. The S-polarized component of the second rotated light beam from second liquid crystal cell 112 propagates along light path 136. Polarizing beam displacer 2 recombines the P-polarized component of the first rotated light beam and the S-polarized component of the second rotated light beam into a single light beam propagating along light path 122 to optical fiber collimator 102, which is located at the output port. In this arrange, the levels of P-polarized component and S-polarized component of light entering optical fiber collimator 102 at the output port can be controlled by varying the external signal voltages applied to first liquid crystal cell 111 and second liquid crystal cell 112.

FIG. 2 shows the configuration of an alternative embodiment that has two optical channels according to this invention. The operation of the first optical channel and the second optical channel is identical to the operation of the single optical channel shown in FIG. 1. The reference numerals of the elements of the first optical channel in FIG. 2 are identical to the reference numerals of the corresponding elements in FIG. 1. The reference numerals of the elements of the second optical channel in FIG. 2 are the same to the reference numerals of the corresponding elements of the first optical channel in FIG. 2 except that the first digit is “2” instead of “1”. The first optical channel and the second optical channel employ common first polarizing beam displacer 1 and second polarizing beam displacer 2.

There are numerous variations to the embodiments above that may be trivial to one skilled in the art. Examples of these variations include but not limited to:

add temperature control to the liquid crystal cells to improve speed and stability;

extend to multiple optical channels;

change the orientation of the beam splitter and/or beam displacers, change the optical arrangement and the signals applied to the liquid crystal cells accordingly; for example, rotate the beam displacer by one hundred and eighty degrees;

use a magneto-optic cell or any polarization rotator cell that is controllable by an external signal instead of a liquid crystal cell; and

the magneto-optic cell or liquid crystal cell may be constructed and arranged to alter the polarization of the light reflected from it instead of transmitted through it as show in the figures, and the optical arrangement will be changed accordingly.

Although the embodiment of the invention has been illustrated and that the form has been described, it is readily apparent to those skilled in the art that various modifications may be made therein without departing from the spirit of the invention.

What is claimed is:

1. A polarization control apparatus, comprising:
a first polarizing beam splitter;
a second polarizing beam splitter; and
at least one polarization control device having an optical input port and an optical output port, and being responsive to a first external signal and a second external signal;
wherein, for each polarization control device:
a first selected polarizing beam splitter selected from said first polarizing beam splitter and said second polarizing beam splitter is disposed to separate a light beam from said optical input port of said polarization control device to a first polarized light beam and a second polarized light beam, the polarizations of said first polarized light beam and said second polarized light beam being substantially mutually orthogonal;
said polarization control device comprises:
a first controlled rotator cell being responsive to said first external signal of said polarization control device for rotating the polarization of said first polarized light beam into a first rotated polarized light beam; and
a second controlled rotator cell being responsive to said second external signal of said polarization control device for rotating the polarization of said second polarized light beam into a second rotated polarized light beam; and
a second selected polarizing beam splitter selected from said first polarizing beam splitter and said second polarizing beam splitter is disposed to combine substantially a predetermined polarization component of said first rotated polarized light beam of said polarization control device and a predetermined polarization component of said second rotated polarized light beam of said polarization control device into a light beam at said optical output port of said polarization control device.

2. The polarization control apparatus as claimed in claim 1, further comprising:
a temperature control system providing temperature control to said polarization control apparatus.

3. The polarization control apparatus as claimed in claim 1 further comprising:
a plurality of said polarization control devices.

4. The polarization control apparatus as claimed in claim 1, wherein, said controlled rotator cell comprises a transmissive liquid crystal cell being responsive to an external signal for rotating the polarization of transmitted light.

5. The polarization control apparatus as claimed in claim 1, wherein, said controlled rotator cell comprises a reflective liquid crystal cell being responsive to an external signal for rotating the polarization of reflected light.

6. The polarization control apparatus as claimed in claim 1, wherein, said controlled rotator cell comprises a transmissive magneto-optic cell being responsive to an external signal for rotating the polarization of transmitted light.

7. The polarization control apparatus as claimed in claim 1, wherein, said controlled rotator cell comprises a reflective magneto-optic cell being responsive to an external signal for rotating the polarization of reflected light.

8. The polarization control apparatus as claimed in claim 1, wherein, said first polarizing beam splitter comprises a polarizing beam displacer.

9. The polarization control apparatus as claimed in claim 1, wherein, said second polarizing beam splitter comprises a polarizing beam displacer.

10. The polarization control apparatus as claimed in claim 1, wherein, said polarization control device further comprises an optical fiber collimator for providing said light beam from said optical input port.

11. The polarization control apparatus as claimed in claim 1, wherein, said polarization control device further comprises an optical fiber collimator for receiving said light beam at said first optical output port.

12. The polarization control apparatus as claimed in claim 10, wherein, said polarization control device further comprises an optical fiber collimator for receiving said light beam at said first optical output port.

13. The polarization control apparatus as claimed in claim 12, further comprising:
a temperature control system providing temperature control to said polarization control apparatus.

14. The polarization control apparatus as claimed in claim 12, further comprising:
a plurality of said polarization control devices.

15. The polarization control apparatus as claimed in claim 12, wherein, said controlled rotator cell comprises a transmissive liquid crystal cell being responsive to an external signal for rotating the polarization of transmitted light.

16. The polarization control apparatus as claimed in claim 12, wherein, said controlled rotator cell comprises a reflective liquid crystal cell being responsive to an external signal for rotating the polarization of reflected light.

17. The polarization control apparatus as claimed in claim 12, wherein, said controlled rotator cell comprises a transmissive magneto-optic cell being responsive to an external signal for rotating the polarization of transmitted light.

18. The polarization control apparatus as claimed in claim 12, wherein, said controlled rotator cell comprises a reflective magneto-optic cell being responsive to an external signal for rotating the polarization of reflected light.

19. The polarization control apparatus as claimed in claim 12, wherein, said first polarizing beam splitter comprises a polarizing beam displacer.

20. The polarization control apparatus as claimed in claim 12, wherein, said second polarizing beam splitter comprises a polarizing beam displacer.

21. A polarization control apparatus, comprising:
a first polarizing beam splitter;
a second polarizing beam splitter; and
a first polarization control device having an optical input port and an optical output port, and being responsive to a first external signal and a second external signal;
wherein:
said first polarizing beam splitter is disposed to separate a light beam from said optical input port of said first polarization control device to a first polarized light beam and a second polarized light beam, the polarizations of said first polarized light beam and said second polarized light beam being substantially mutually orthogonal;
said first polarization control device comprises:
a first controlled rotator cell being responsive to said first external signal of said first polarization control device for rotating the polarization of said first polarized light beam into a first rotated polarized light beam; and
a second controlled rotator cell being responsive to said second external signal of said first polarization control device for rotating the polarization of said second polarized light beam into a second rotated polarized light beam; and
said second polarizing beam splitter is disposed to combine substantially a predetermined polarization component of said first rotated polarized light beam of said first polarization control device and a predetermined polarization component of said second rotated polarized light beam of said first polarization control device into a light beam at said optical output port of said first polarization control device.

22. The polarization control apparatus as claimed in claim 21 further, comprising:
a second polarization control device having an optical input port and an optical output port, and being responsive to a first external signal and a second external signal.

23. The polarization control apparatus as claimed in claim 22, wherein:
said first polarizing beam splitter is disposed to separate a light beam from said optical input port of said second polarization control device to a third polarized light beam and a fourth polarized light beam, the polarizations of said third polarized light beam and said fourth polarized light beam being substantially mutually orthogonal;
said second polarization control device comprises:
a first controlled rotator cell being responsive to said first external signal of said second polarization control device for rotating the polarization of said third polarized light beam into a third rotated polarized light beam; and
a second controlled rotator cell being responsive to said second external signal of said second polarization control device for rotating the polarization of said fourth polarized light beam into a fourth rotated polarized light beam; and
said second polarizing beam splitter is disposed to combine substantially a predetermined polarization component of said third rotated polarized light beam and a predetermined polarization component of said fourth rotated polarized light beam into a light beam at said optical output port of said second polarization control device.

24. The polarization control apparatus as claimed in claim 23, further comprising:
a first optical fiber collimator for providing said light beam from said optical input port of said first polarization control device;
a second optical fiber collimator for receiving said light beam at said optical output port of said first polarization control device;
a third optical fiber collimator for providing said light beam from said optical input port of said second polarization control device; and
a fourth optical fiber collimator for receiving said light beam at said optical output port of said second polarization control device.

25. The polarization control apparatus as claimed in claim 24, further comprising:
a temperature control system providing temperature control to said polarization control apparatus.

26. The polarization control apparatus as claimed in claim 24, wherein, said controlled rotator cell comprises a transmissive liquid crystal cell being responsive to an external signal for rotating the polarization of transmitted light.

27. The polarization control apparatus as claimed in claim 24, wherein, said controlled rotator cell comprises a reflective liquid crystal cell being responsive to an external signal for rotating the polarization of reflected light.

28. The polarization control apparatus as claimed in claim 24, wherein, said controlled rotator cell comprises a transmissive magneto-optic cell being responsive to an external signal for rotating the polarization of transmitted light.

29. The polarization control apparatus as claimed in claim 24, wherein, said controlled rotator cell comprises a reflective magneto-optic cell being responsive to an external signal for rotating the polarization of reflected light.

30. The polarization control apparatus as claimed in claim 24, wherein, said first polarizing beam splitter comprises a polarizing beam displacer.

31. The polarization control apparatus as claimed in claim 24, wherein, said second polarizing beam splitter comprises a polarizing beam displacer.

32. The polarization control apparatus as claimed in claim 22, wherein:
said second polarizing beam splitter is disposed to separate a light beam from said optical input port of said second polarization control device to a third polarized light beam and a fourth polarized light beam, the polarizations of said third polarized light beam and said fourth polarized light beam being substantially mutually orthogonal;
said second polarization control device comprises:
a first controlled rotator cell being responsive to said first external signal of said second polarization control device for rotating the polarization of said third polarized light beam into a third rotated polarized light beam; and
a second controlled rotator cell being responsive to said second external signal of said second polarization control device for rotating the polarization of said fourth polarized light beam into a fourth rotated polarized light beam; and
said first polarizing beam splitter is disposed to combine substantially a predetermined polarization component of said third rotated polarized light beam and a predetermined polarization component of said fourth rotated polarized light beam into a light beam at said optical output port of said second polarization control device.

33. The polarization control apparatus as claimed in claim 32, further comprising:
a first optical fiber collimator for providing said light beam from said optical input port of said first polarization control device;
a second optical fiber collimator for receiving said light beam at said optical output port of said first polarization control device;
a third optical fiber collimator for providing said light beam from said optical input port of said second polarization control device; and
a fourth optical fiber collimator for receiving said light beam at said optical output port of said second polarization control device.

34. The polarization control apparatus as claimed in claim 33, further comprising:
a temperature control system providing temperature control to said polarization control apparatus.

35. The polarization control apparatus as claimed in claim 33, wherein, said controlled rotator cell comprises a transmissive liquid crystal cell being responsive to an external signal for rotating the polarization of transmitted light.

36. The polarization control apparatus as claimed in claim 33, wherein, said controlled rotator cell comprises a reflective liquid crystal cell being responsive to an external signal for rotating the polarization of reflected light.

37. The polarization control apparatus as claimed in claim 33, wherein, said controlled rotator cell comprises a transmissive magneto-optic cell being responsive to an external signal for rotating the polarization of transmitted light.

38. The polarization control apparatus as claimed in claim 33, wherein, said controlled rotator cell comprises a reflective magneto-optic cell being responsive to an external signal for rotating the polarization of reflected light.

39. The polarization control apparatus as claimed in claim 33, wherein, said first polarizing beam splitter comprises a polarizing beam displacer.

40. The polarization control apparatus as claimed in claim 33, wherein, said second polarizing beam splitter comprises a polarizing beam displacer.
